(19) United States
(12) Patent Application Publication
(10) Pub. No.: US 2026/0202849 A1
(43) Pub. Date: Jul. 16, 2026

(54) AUTONOMOUS NAVIGATION IN UNKNOWN SPACES

(71) Applicant: CARMEL HAIFA UNIVERSITY ECONOMIC CORPORATION LTD., Haifa (IL)

(72) Inventors: Yosi BEN ASHER, Haifa (IL); Danial JERYES, Nazareth (IL)

(21) Appl. No.: 19/135,405

(22) PCT Filed: Dec. 4, 2023
(86) PCT No.: PCT/IL2023/051239

§ 371 Date: Jun. 4, 2025

(30) Foreign Application Priority Data
Dec. 4, 2022 (IL) 298807

(51) Int. Cl. G05D 1/622; G05D 1/241; G05D 105/80

(52) U.S. Cl. CPC G05D 1/622; G05D 1/241; G05D 2105/87

(57) ABSTRACT

An autonomous device, and a method of controlling thereof may include one or more motors, one or more proximity sensors, and at least one controller associated with said motors and proximity sensors. The at least one controller may be configured to continuously: receive, from the one or more proximity sensors, indications of obstacle proximity; based on the indications of obstacle proximity, maintain a current state of a state-machine comprising a plurality of states, wherein each state defines a general direction for conducting the device; and control said one or more motors to conduct the device in a zigzag motion, skewed by a precalculated skew angle α in relation to the general direction, as defined by the current state.

### CROSS-REFERENCE TO RELATED APPLICATIONS

This application claims the benefit of Israeli Patent Application No. 298807, filed Dec. 4, 2022, which is hereby incorporated by reference in its entirety.

### FIELD OF THE INVENTION

The present invention relates generally to the field of autonomous devices and robotics. More specifically, the present invention relates to conducting an autonomous device, e.g., for scanning unknown spaces.

### BACKGROUND OF THE INVENTION

A fundamental and difficult problem in the study of autonomous vehicles is that of autonomous navigation in an unknown maze of obstacles. The problem has the following challenging characteristics:

Autonomous vehicles or devices such as drones should fly in an indoor environment such as rooms connected by corridors and staircases or in a maze of tunnels. Often this environment is unknown.

Such environments may be modeled by an unknown maze of walls and obstacles that the device (e.g., drone) must scan/search, i.e., cover most of its parts (rooms, corridors, and corners). The autonomous device must constantly compute and update an obstacle-free path bypassing obstacles and unveiling new unknown spaces such as entrances such as doors, openings, performing turns, etc. This requires an algorithm for traversing an unknown maze or finding an obstacle free path, also referred to in the art as “way points”.

However, due to limited communication with the outside of the maze or space, and lack of GPS availability, the autonomous device (e.g., drone) must fly autonomously making all computations and control on-board. Additionally, when using light drones, having limited computing resources, extensive computations must be avoided.

Thus, there is a need for a system and method that can work on lightweight, low-powered, CPU-embedded Printed Circuit Boards (PCBs), to autonomously scan and map unknown spaces.

### SUMMARY OF THE INVENTION

Embodiments of the invention may include an autonomous device, such as a drone, that may include one or more motors, one or more proximity sensors, and at least one controller, associated with said motors and proximity sensors.

The at least one controller may be configured to continuously receive, from the one or more proximity sensors, indications of obstacle proximity. Based on the indications of obstacle proximity, the at least one controller may continuously maintain a state-machine that may include a plurality of states. Each state of the state machine may pertain to, or define a general direction for conducting the device. The term “maintaining” may be used in this context to indicate continuous determination of a current state of the state machine, as known in the art. As elaborated herein, by maintaining current states of the state machine, embodiments of the invention may implement specific decisions for conducting the autonomous device.

According to some embodiments, the at least one controller may control said one or more motors, e.g., via a control signal as known in the art, to conduct the device in a zigzag motion. The zigzag motion may be skewed by a precalculated skew angle α in relation to the general direction, as defined by the current state.

For example, as elaborated herein (e.g., in relation to FIG. 4), the plurality of states may include at least four states (denoted herein as up-forward, up-backward, right-forward and right-backward), corresponding to at least four respective orthogonal general directions (e.g., {up-forward, up-backward, right-forward and right-backward} directions or {forward, backward, right and left} directions).

According to some embodiments, at least one state may be associated with a respective counter. A value of the counter may represent repetitions of proximity of the device to a furthermost position in the defined general direction.

According to some embodiments, the controller may be configured to recalculate skew angle α when a value of the counter surpasses a first threshold, and subsequently control the one or more motors to conduct the device based on the recalculated skew angle α.

Additionally, or alternatively, the controller may be configured to switch the current state of the state machine to another state (referred to herein as a “next” state), that corresponds to an opposite general direction, when a value of the counter surpasses a second threshold. The controller may subsequently conduct the device based on the opposite general direction.

Additionally, or alternatively, the at least one controller may be configured to conduct the device in a zigzag motion by controlling the one or more motors, to conduct the device in a first direction that may be skewed by skew angle α in relation to the general direction, until a first indication of obstacle proximity (e.g., lateral obstacle proximity) may be received from the one or more (e.g., a first) proximity sensors. The at least one controller may subsequently control the one or more motors, to conduct the device in a second direction that may be skewed by a second angle, that is complementary to skew angle α, in relation to the general direction. The at least one controller may conduct the device in the second angle until a second indication of obstacle proximity (e.g., lateral obstacle proximity) is received from the one or more (e.g., a second) proximity sensors.

According to some embodiments, the at least one controller may be configured to repeat the zigzag motion until an indication of obstacle proximity (e.g., frontal obstacle proximity) may be received from the one or more proximity sensors.

Additionally, or alternatively, the at least one controller may be configured to, upon receiving the indication of frontal obstacle proximity: (i) update the furthermost position in the defined general direction based on a current position of the device; and (ii) update the counter based on the current position of the device.

According to some embodiments, the autonomous device may include, or may be communicatively connected to an accelerometer, configured to produce measurements of at least one of an acceleration and a velocity of the autonomous device. The at least one controller may be configured to receive said measurements, and calculate the current position of the device based on said measurements.

According to some embodiments, the at least one controller may be configured to, when a value of the counter surpasses a third threshold: (i) log a current position of the device; (ii) switch the current state of the state machine to a next state, that corresponds to an orthogonal general direction; and (iii) conduct the device based on the orthogonal general direction.

Additionally, or alternatively, the at least one controller may be further configured to: (i) when a furthermost position of the device, in the orthogonal general direction exceeds the logged position, then defining an area surrounding the logged position as a virtual barrier; and (ii) avoid conducting the device through the virtual barrier.

According to some embodiments, the controller may be further configured to receive a boundary data element, defining boundaries of an area of interest; divide the area of interest to a plurality of sections, according to a predefined resolution; and count a number of sections that the device has traversed during said conduction. Additionally, or alternatively, the controller may provide an indication of area coverage based on said counting.

Embodiments of the invention may include a method of controlling an autonomous device by at least one processor mounted on said device. Embodiments of the method may include: continuously receiving, from one or more proximity sensors mounted on said device, indications of obstacle proximity; based on the indications of obstacle proximity, maintaining a current state of a state-machine may include a plurality of states, wherein each state defines a general direction for conducting the device; and controlling one or more motors mounted on said device, to conduct the device in a zigzag motion, skewed by a precalculated skew angle α in relation to the general direction, as defined by the current state.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for controlling an autonomous device according to some embodiments of the invention;

FIG. 2 is a block diagram, depicting a system for controlling an autonomous device according to some embodiments of the invention;

FIG. 3 is an image depicting a result of a simulated experiment, where an autonomous device is set to scan a maze, as known in the art;

FIG. 4 is a diagram depicting a set operations and states for conducting an autonomous device, according to some embodiments of the invention;

FIG. 5 is a schematic diagram depicting additional examples for transition between states of the autonomous vehicle, according to some embodiments of the invention;

FIG. 6 is a schematic diagram depicting a simulated example, showing an effect of selection of a skew angle α on a probability of traversing an obstacle, according to some embodiments of the invention;

FIG. 7 is a schematic diagram depicting another simulated example, showing an effect of selection of a skew angle α on a probability of traversing an obstacle, according to some embodiments of the invention;

FIG. 8 is schematic diagram depicting examples for transition between states of the autonomous vehicle, according to some embodiments of the invention;

FIG. 9 is an image depicting a result of a simulated experiment, where an autonomous device is set to scan a 50×42 maze, according to some embodiments of the invention;

FIG. 10 is an image depicting an example of a three-dimensional (3D) model of a maze as scanned, or traversed by an autonomous device, according to some embodiments of the invention; and

FIG. 11 is a flow diagram depicting a method of controlling an autonomous device by at least one processor or controller, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

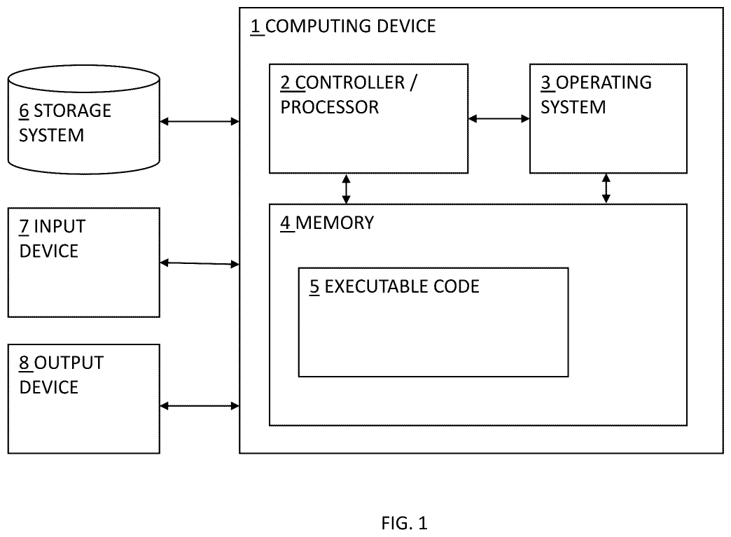

Reference is now made to FIG. 1, which is a block diagram depicting a computing device, which may be included within an embodiment of a system for controlling an autonomous device, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Controller or processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may control an autonomous device, as further described herein. Although, for the sake of clarity, a single item of executable code 5 is shown in FIG. 1, a system according to some embodiments of the invention may include a plurality of executable code segments similar to executable code 5 that may be loaded into memory 4 and cause controller or processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to a scanned area may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

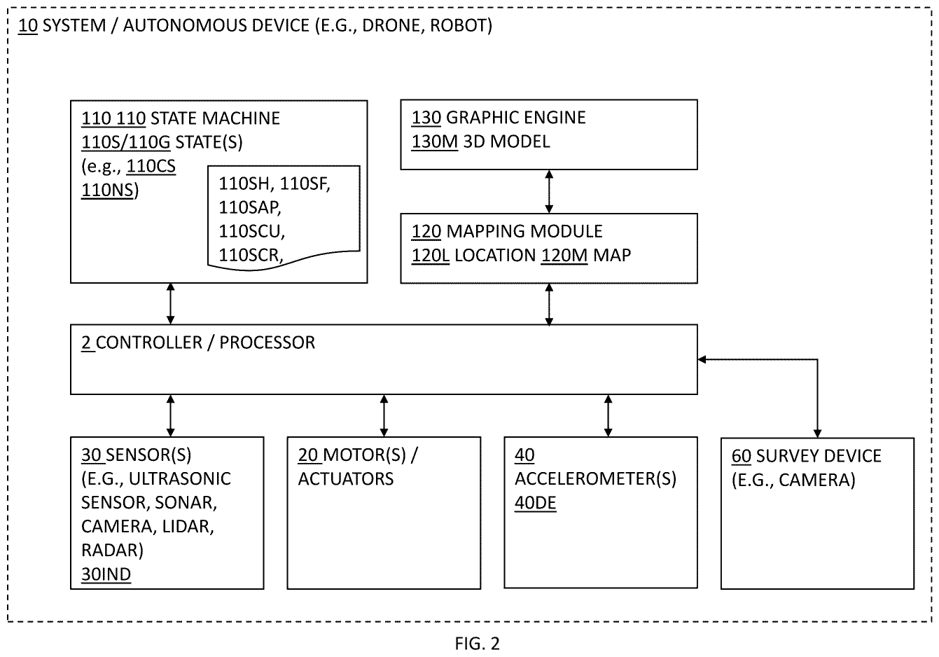

Reference is now made to FIG. 2, which depicts a system 10 for controlling an autonomous device, according to some embodiments. As elaborated herein, components of system 10 may be included in, or mounted on the autonomous device, to facilitate autonomous conduction of a device, as elaborated herein. In that respect, the terms “system 10”, “autonomous device 10”, “device 10”, “robot 10” and “drone 10” may be used herein interchangeably, to indicate a device that may be conducted autonomously according to embodiments of the invention, as elaborated herein.

According to some embodiments of the invention, system 10 may be implemented as a software module, a hardware module, or any combination thereof. For example, system 10 may be or may include a computing device such as element 1 of FIG. 1, and may be adapted to execute one or more modules of executable code (e.g., element 5 of FIG. 1) to control one or more motors or actuators 20 (e.g., propellers) to conduct an autonomous device 10 such as a drone, as described herein.

As shown in FIG. 2, arrows may represent flow of one or more data elements or signals to and from system 10 and/or among modules or elements of system 10.

As elaborated herein, system 10 may include at least one controller or processor 2 (e.g., such as controller 2 of FIG. 1), configured to conduct device 10 through an unchartered or unmapped predefined area or territory, also referred to herein as a maze, to traverse through, survey, or cover as much area of predefined area, in a time-wise optimal manner.

As known in the art, currently available methods may fuse IMU (inertial measurement unit) with sonar data, and use SLAM to compute localization, and produce a 3D map. Currently available methods subsequently compute an obstacle-free path by dividing the 3D-map occupied/free coarse-grained grid cells, and may compute an obstacle-free path (waypoints) towards a pre-designated target.

Embodiments of the invention may include a conduction algorithm that may allow a drone to traverse or scan an unknown maze without going through the aforementioned steps of a) localization, b) generation of the 3D-map, and c) computing an obstacle-free path. Embodiments of the invention may conduct device 10 by performing blind zig-zag movements (ergodic billiard-like movements) where the drone flies straight at angle α until it detects a close obstacle. At this point, device 10 may turns at angle (α-90), and (like a billiard ball) flies straight until detecting another obstacle, and so forth. In certain situations such as arriving at a point multiple times, the algorithm may randomly change a. A PID controller generates a realistic quadcopter flight (e.g., performing a turn in a corner). These zig-zag movements may create a random sampling of the maze walls and automatically by-pass obstacles.

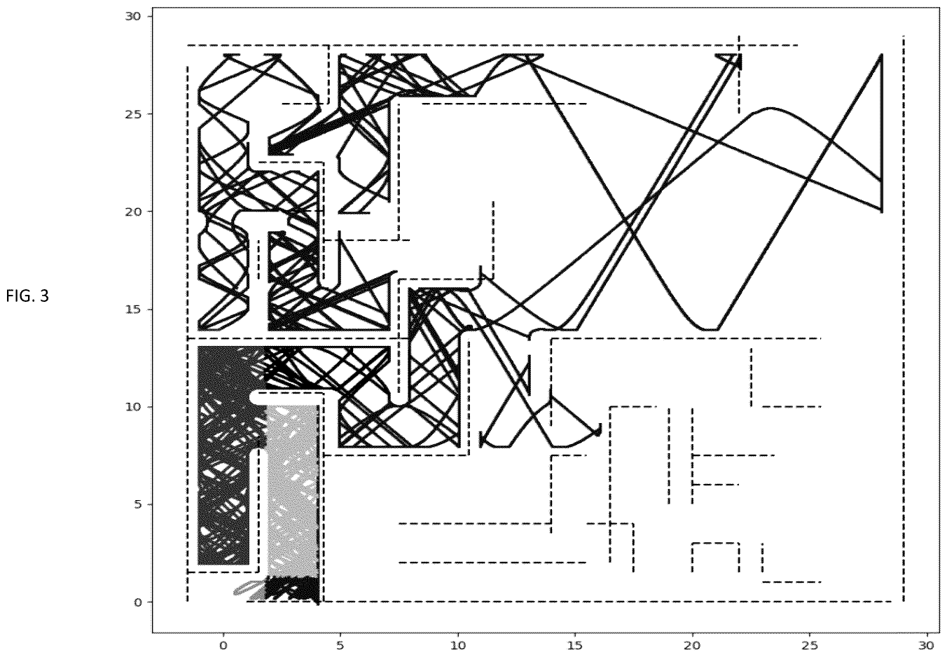

Reference is made to FIG. 3, which is an image depicting a result of a simulated experiment, where an autonomous device is set to scan a maze, as known in the art;

It has been experimentally and simulatively observed that merely using random zig-zag movements was not enough to obtain an efficient scan of the maze. FIG. 1 shows that multiple scans of the same area (repeated color lines in the figure) can occur when using just random zigzag movements. Essentially FIG. 3 shows inability to escape dead-end corridors. Embodiments of the invention may exploit this observation, for refining the conduction algorithm. Accordingly, the conduction algorithm may include Using different types of zigzag movements; and inserting virtual obstacles, also referred to herein as “bad-regions” to prevent device 10 from rescanning an already scanned area.

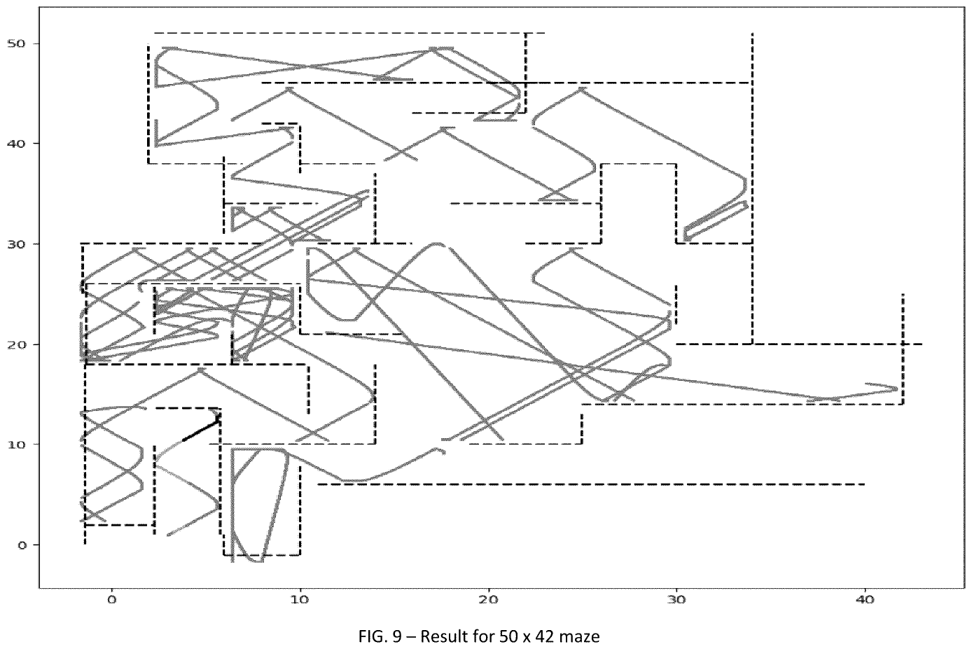

In the following discussion, The maze is assumed to be a rectangle with one entrance located on one of the four edges of this rectangle. The maze consists of a set of vertical and horizontal walls as depicted for example in FIG. 3 and FIG. 9.

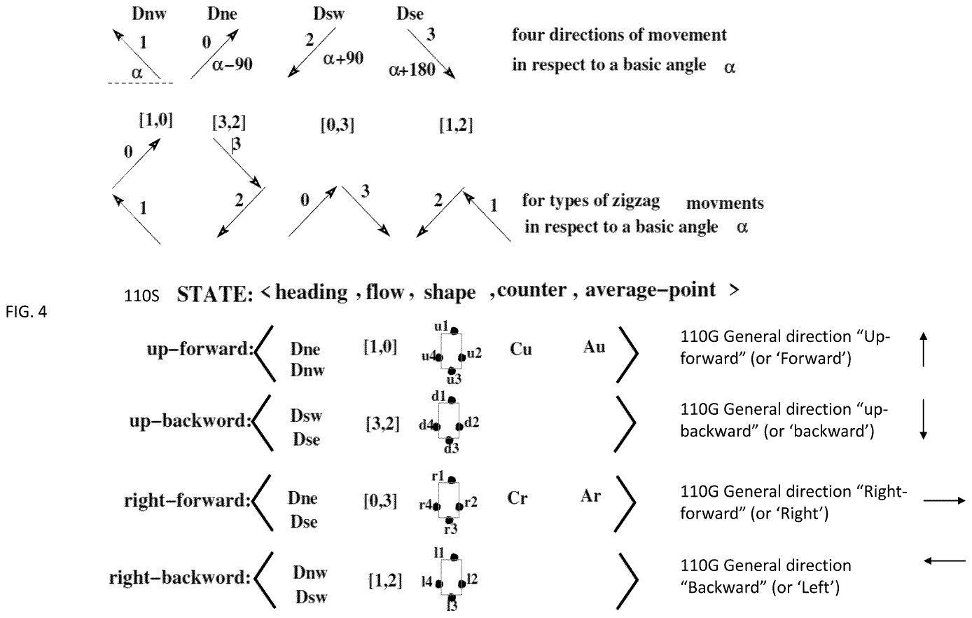

Reference is made to FIG. 4, which is a diagram depicting a set operations and states for conducting an autonomous device, according to some embodiments of the invention. The conduction algorithm may use the following set of basic operations and states, as depicted in FIG. 4:

Directions of movement: There are four directions of movement, also referred to herein as “general directions”, in respect to a basic angle α. These are depicted in FIG. 4 as Dne, Dnw, Dse, and Dsw (FIG. 4 top). The angle of these movements may be measured with respect to a horizontal line that is parallel to the maze's bottom (e.g., as shown by the dashed line of Dne, in FIG. 4).

When device 10 (e.g., a drone) changes direction e.g., from Dse to Dne, it may turn until it is on a desired angle α, and then move straight until an obstacle detection occurs. The Obstacle Detection Threshold (ODTH), e.g., a distance between the drone and the obstacle, may be selected such that there is enough room for the drone to turn in any desired direction. Thus, the conduction algorithm may change direction of device 10 only when the drone detects a close object in its flight direction.

Zigzag movements: There are four types of zigzag movements with respect to a basic angle α that the algorithm may use. These are denoted herein as [1; 0], [3; 2], [0; 3], and [1; 2], as depicted in FIG. 4.

When a zigzag movement is selected, drone 10 may keep alternating between two directions. For example, in relation to zigzag motion [1; 0], drone 10 may repeatedly alternate its direction of flight between Dne and Dnw. The zigzag movement may always be in a right/left shift of 90° in relation to the basic angle, as depicted in FIG. 4 bottom.

During operation, the conduction algorithm can use a different basic angle for these four types of movements, e.g., use a basic angle α of 25.5°.

State machine 110: Controller or processor 2 may maintain a state machine 110, having a plurality of states 110S. In this example, state machine 110 may include four states 110S, denoted herein as {up-forward, up-backward, right-forward and right-backward}. Each state may correspond to a respective general direction 110G, also denoted herein as {up-forward, up-backward, right-forward and right-backward} or {forward, backward, right, and left}.

Each state 110S may contain a plurality (e.g., five) fields:

A heading field 110SH may indicate the recent direction in which the drone 10 has flown until it reaches an obstacle. For example, the recent direction in the up-forward state 110S can be either Dne or Dnw.

A flow field 110SF may indicate a motion type, namely the zigzag movement and angle α. For example, in state up-forward 110S the zigzag movement may be {[1; 0], 25.5°}

A shape field 110SS may indicate an ordered set of four points corresponding to the, uppermost, rightmost, lowermost and leftmost points that the drone had reached during its flight in a respective zigzag movement.

For example, points u1, u2, u3, and u4 may respectively represent the, uppermost, rightmost, lowermost and leftmost points that the drone had reached during its flight in the up-forward general direction 110G. Each of the other states may have its own shape field, defining respective points: the up-backward right-forward and right-backward states may have shape points {d1, d2, d3, d4}, {r1, r2, r3, r4}, and {l1, l2, l3, l4}, respectively.

These points may be globally kept for each state and may be used to estimate the area the drone has covered in the last four states.

Average point 110SAP: The state average point 110SAP may be computed only for the up-forward and the right-forward states 110S (of the up-forward and right-forward general directions 110G) as follows:
For the up-forward state 110S, initialize Au=u1. Let Obstacle Detection Point (ODP) be defined as the last point wherein the drone detected a close obstacle (wall, corner, etc.). If the distance (ODP; Au)<ODTH then Au=geometric average between (Au; ODP). Otherwise, Au is unchanged.

For the left-forward state 110S (left-forward general direction 110G), Initialize Ar=r2. Let ODP be the last point wherein the drone detected a close obstacle. If the distance (ODP; Au)<ODTH then Au=geometric average between (Au; ODP). Otherwise, Au is unchanged.

Embodiments of the invention may use a counter 110Scu or 110SCr, to count a number of times that autonomous device (e.g., drone) 10 was close to an average point, i.e., when distance (ODP; Au=Ar)<ODTH. The conduction algorithm may use transitions from a current 110S (e.g., 110CS) of state machine 110 to a new state, or next state 110S (e.g., 110NS) of state machine 110, to move between states.

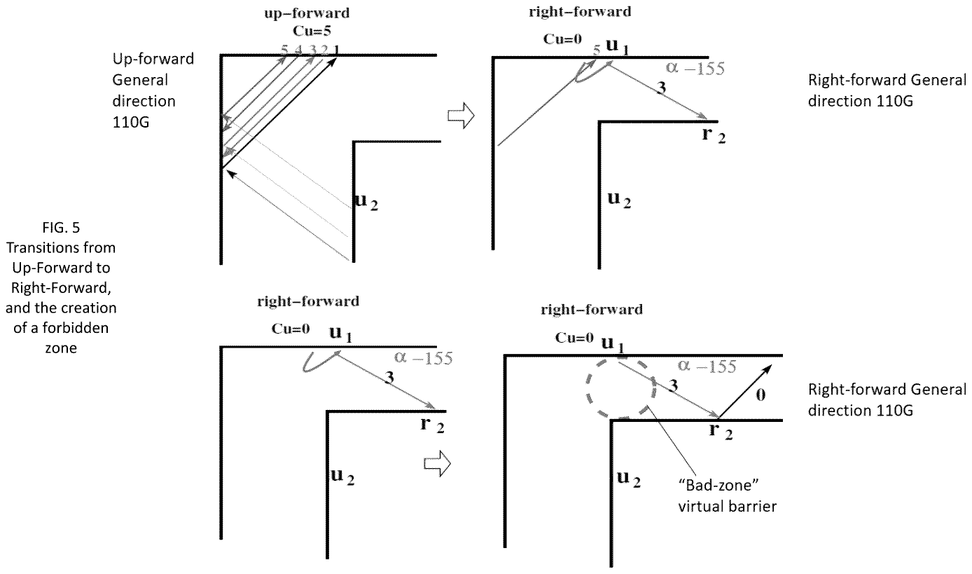

Reference is also made to FIG. 5, which is a schematic diagram depicting examples for transition between states of the autonomous vehicle, according to some embodiments of the invention.

Controller or processor 2 may execute these transitions whenever the drone detects a close obstacle upon which the algorithm executes the suitable transition. The transitions can be classified into three main groups or categories:
Group 1 may include transitions from up-forward to back-forward states 110S, and vice-versa (from up-forward to back-forward general direction 110G, and vice-versa). These transitions may occur when drone 10 hits a dead-end corridor or room. In these cases, drone 10 may switch from forward general direction 110G to backward direction 110G in zigzag movement. By doing so, drone 10 will likely sample different points of this corridor, and possibly detect a new exit out of this corridor.

$$〈 Dne , {[ 1 , 0 ]}_{α - 90} , u 1 , u 2 , u 3 , u 4 , Cu == 0 , Au 〉 {⟹}^{d ( odp , Au ) > Thr} 〈 Dnw , {[ 1 , 0 ]}_{α} , u {1}^{′} = upmost ( u 1 , odp ) , u 2 , u 3 , u 4 = leftmost ( u 4 , odp ) , Cu = 0 , Au 〉$$

$$〈 Dnw , {[ 1 , 0 ]}_{α} , u 1 , u 2 , u 3 , u 4 , Cu == 0 , Au 〉 {⟹}^{d ( odp , Au ) < Thr} 〈 Dne , {[ 1 , 0 ]}_{α - 90} , u {1}^{′} = upmost ( u 1 , odp ) , u 2 = rightmost ( u 2 , odp ) , u 3 , u 4 Cu = 1 , Au = between ( odp , Au , u 1 ) 〉$$

$$〈 Dne , {[ 1 , 0 ]}_{α - 90} , u 1 , u 2 , u 3 , u 4 , Cu == 1 , Au 〉 {⟹}^{d ( odp , Au ) < Thr} 〈 Dnw , {[ 1 , 0 ]}_{α} , u {1}^{′} = upmost ( u 1 , odp ) , u 2 , u 3 , u 4 = leftmost ( u 4 , odp ) Cu = 2 , Au = between ( odp , Au , u 1 ) 〉$$

$$〈 Dnw , {[ 1 , 0 ]}_{α} , u 1 , u 2 , u 3 , u 4 , Cu == 2 , Au 〉 {⟹}^{d ( odp , Au ) < Thr} 〈 Dsw , {[ 2 , 3 ]}_{α + 75} , d 1 = odp , d 2 = odp , d 3 = odp , d 4 = odp , Cu = 2 , Au 〉$$

Group 2 may include transitions from up-forward to right-forward states 110S (e.g., from up-forward to right-forward general directions 110G) that may also add a forbidden zone. Such transitions may occur when drone 10 detects a corner and the counter 110SCU exceeds a predefined number (e.g., 110SCU≥5). In such conditions, controller or processor 2 may assume that drone 10 has made two up-forward 110G and up-backward 110G sweeps, followed by one last up-forward pass 110G, and did not find another exit. Controller or processor 2 may thus assume that drone has covered an up-forward+up-backward rectangle, i.e., the drone covered a corridor that ends with a T-junction and needs to exit through the opposite corner it came in. Hence, drone 10 may need to change the zigzag movement, e.g., from [0; 1] to [3; 0]. This group may include transitions such as:

$$〈 Dne , {[ 1 , 0 ]}_{α} , u 1 , u 2 , u 3 , u 4 , Cu == 5 , Au 〉 ⇒ 〈 Dse , {[ 0 , 3 ]}_{α + 75} , r 2 = odp , r 1 = odp , r 3 = odp , r 4 = odp , Cu = 0 , Au = ∅ 〉$$

This is depicted in the upper portion of FIG. 4, which shows the change of direction. Note that in this example, the change of the heading to Dse is due to the drone's previous heading to Dne. Had the drone 10 been heading to Dnw, the transition would have been:

$$〈 Dnw , {[ 1 , 0 ]}_{α} , u 1 , u 2 , u 3 , u 4 , Cu == 5 , Au 〉 ⇒ 〈 Dne , {[ 0 , 3 ]}_{α + 75} , r 2 = odp , r 1 = odp , r 3 = odp , r 4 = odp , Cu = 0 , Au = ∅ 〉$$

In this example, the change is from up-forward state 110S to right-forward state 110S (up-forward general direction 110G to right-forward general direction 110G). After this turn, at the next obstacle detection, drone 10 will continue the zigzag movement of [0; 3] using the transition:

$$〈 Dse , {[ 3 , 0 ]}_{α + 180} , r 1 , r2 , r 3 , r 4 , Cu == 0 , Au = ∅ 〉 ⇒ 〈 Dne , {[ 3 , 0 ]}_{α - 90} , r {2}^{′} = rightmost ( r 2 , odp ) , r 1 , r 4 , r {3}^{′} = downmost ( r 3 , odp ) Cu = 1 , Au = odp 〉$$

However, in this last transition, being the first after a change of general direction 110G (e.g., from up-forward to right-forward) controller or processor 2 may also create a “bad-region”, which is depicted as a dashed-circle in the bottom portion of FIG. 5. This may be done to prevent the drone from re-scanning the region defined by {u1, u2, u3, u4}. The bad region may be equal to a virtual circle-like obstacle: The center of this circle may be placed at X=u2.x; Y=average (u1.y; r2.y). as depicted in the bottom portion of FIG. 5. The radius of the virtual object may be is set to (u1.y−r2.y)/2, so as to block what may be the corner from which drone 10 came.

The conditions for creating a bad-region may include: (A) a change of flow, and (B) r2.x>u2.x.

Group 3 may include randomly reducing the return angle and/or angle α. Controller or processor 2 may apply this operation when the heading of drone 10 is changed from up-backward or right-backward general direction 110G back to up-forward or right-forwards general direction 110G at the second time (e.g., when 110Scu=2). For this type of transition, controller or processor 2 may compute the IOU (Intersection over Union) area, as defined by equation Eq. 1, below:

IOU=[area(u1;u2;u3;u4)∩area(d1;d2;d2;d3)]/[area(u1;u2;u3;u4)∪area(d1;d2;d2;d3)]. Eq. 1

Intuitively, if IOU is close to one, it may imply that drone 10 was not able to increase the area searched in a forward [0; 1] pass followed by a backward [2; 3] pass, compared to the area searched in either the forward [0; 1] pass or the backward [2; 3] pass.

If IOU falls below a predefined threshold (e.g., IOU≤1.75), controller or processor 2 may regard it as far from one, and decrease the return angle by calculating or randomly selecting another angle, e.g., 56°, 67°, 78°, or 89° to execute the following transition:

$$〈 Dse , {[ 2 , 3 ]}_{α} , d 1 , d 2 , d 3 , d 4 , 5 > Cu \geq 2 , Au 〉 {⟹}^{d ( odp , Au ) ¡ Th} 〈 Dne , {[ 1 , 0 ]}_{α = rand ( - 56 , - 67 , - 78 , - 89 )} , u {2}^{′} = rightmost ( u 2 , odp ) , u 2 , u 3 , u 4 Cu , Au 〉$$

According to some embodiments, controller or processor 2 may randomly change a so that more, and different points will be sampled on this second up-backward 110G pass.

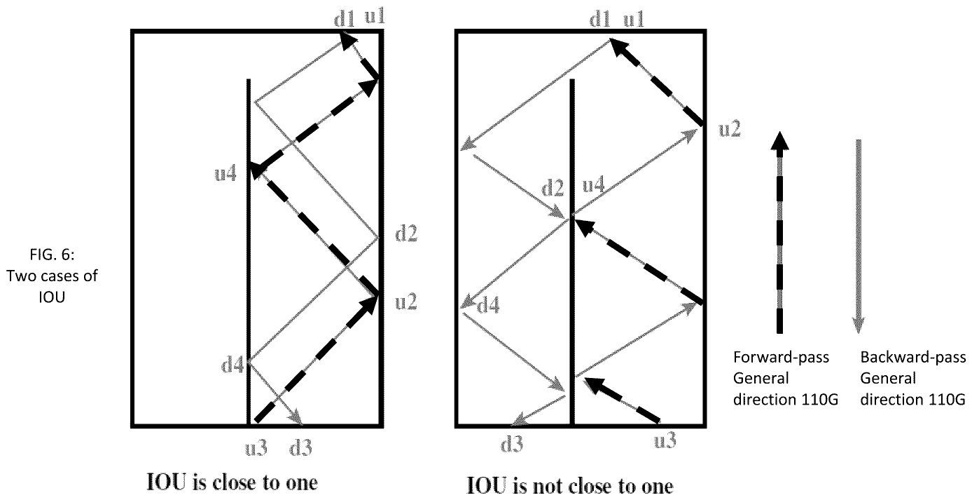

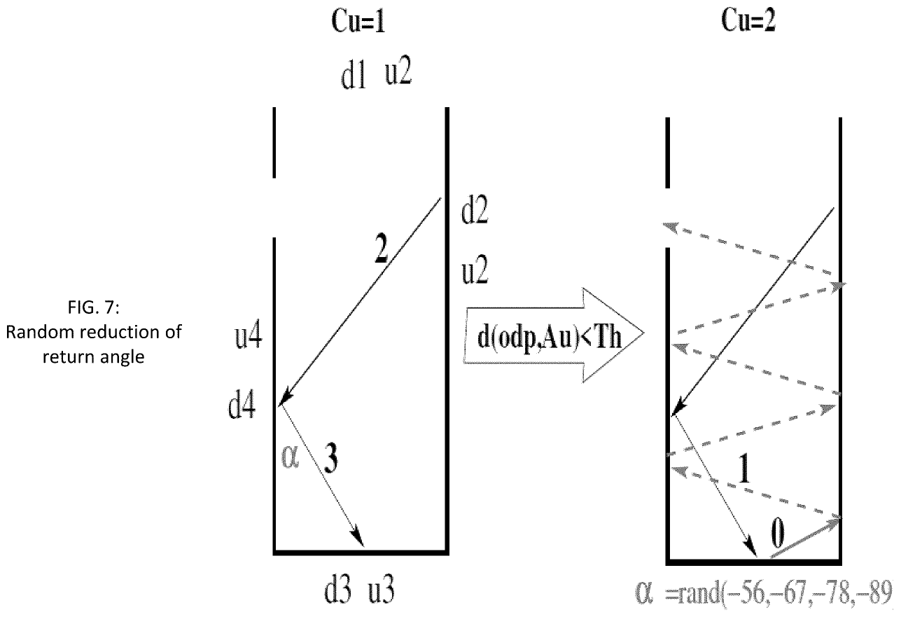

Reference is also made to FIG. 6 and FIG. 7, which are schematic diagrams depicting simulated examples. Each of the examples of FIGS. 6 and 7, may show an effect of selection of a skew angle α on a probability of traversing an obstacle, according to some embodiments of the invention. For example, FIG. 7 illustrates discovery of an exit that was missed on the previous two passes.

When IOU exceeds a predefined threshold (e.g., IOU>0.75), then controller or processor 2 may regard it as close to one and may therefore maximize the number of zigzag movements in the following [0; 1] pass, by setting the return angle to 56°, thereby looking for an opening that was missed so far:

$$〈 Dse , {[ 2 , 3 ]}_{α} , d 1 , d 2 , d 3 , d 4 , 5 > Cu \geq 2 , Au 〉 {⟹}^{d ( odp , Au ) ¡ Th} 〈 Dne , {[ 1 , 0 ]}_{α = - 56} , u {2}^{′} = rightmost ( u 2 , odp ) , u 2 , u 3 , u 4 Cu , Au 〉$$

It may be appreciated that the conduction algorithm may include additional exemplary state transitions, that may relate to specific applications of system 10, and may be derived from the transitions elaborated herein.

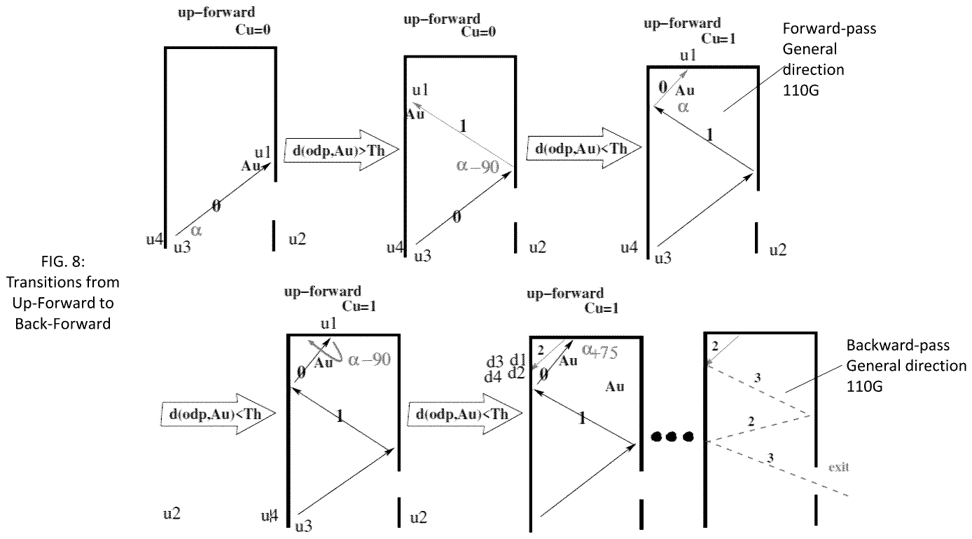

Reference is now made to FIG. 8, which is a schematic diagram depicting examples for transition between states of autonomous vehicle 10, according to some embodiments of the invention.

According to some embodiments, controller 2 may use a binary type of obstacle detection operation that may interrupts drone 10 when it is too close, in its current direction of flight, to an object. The obstacle detection operation may be selected such that the drone's distance from the object will allow it to turn at any desired angle without hitting another obstacle. Such a transition is illustrated as an example in the bottom-middle portion of FIG. 8.

State transition: controller 2 may perform a state transition every time drone 10 detects a close object. Hence at any time, the drone may either (i) fly according to the heading of the current state, or (ii) turning to a new heading, according to one of the state transitions, as elaborated herein.

Controller 2 may update shape and the Au of the current state based on the ODP whenever a state transition occurs. Additionally, or alternatively, Controller 2 may compute Bad region and the IOU at each state transition.

The term “Obstacle Detection Point” (ODP) may be used herein to indicate a position, or coordinates of drone 10 when it detects an obstacle. Controller 10 may initially-assume that drone 10 is placed inside the maze at a known position, forming the first ODP.

According to some embodiments, controller 10 may receive an initial state 110S, and corresponding attributed fields (e.g., heading and zigzag movement) from a user (e.g., via input 7 of FIG. 1).

According to some embodiments, controller 10 may perform turning operations by controlling the one or more motors 20 to decreasing the drone velocity in one axis and increasing it in another axis for a fixed time duration. If an obstacle detection occurs during this time duration, then controller 10 may assume that drone 10 is “stuck” in a corner. In such cases, controller 10 may conduct drone 10 to reverses back a small distance and then retry, or resume to turning operation. The reversing may be performed by changing the clock direction of the drone's X-axis engines. The ODP may be updated according to the reversal and/or turning steps that have been used as depicted in FIG. 3.

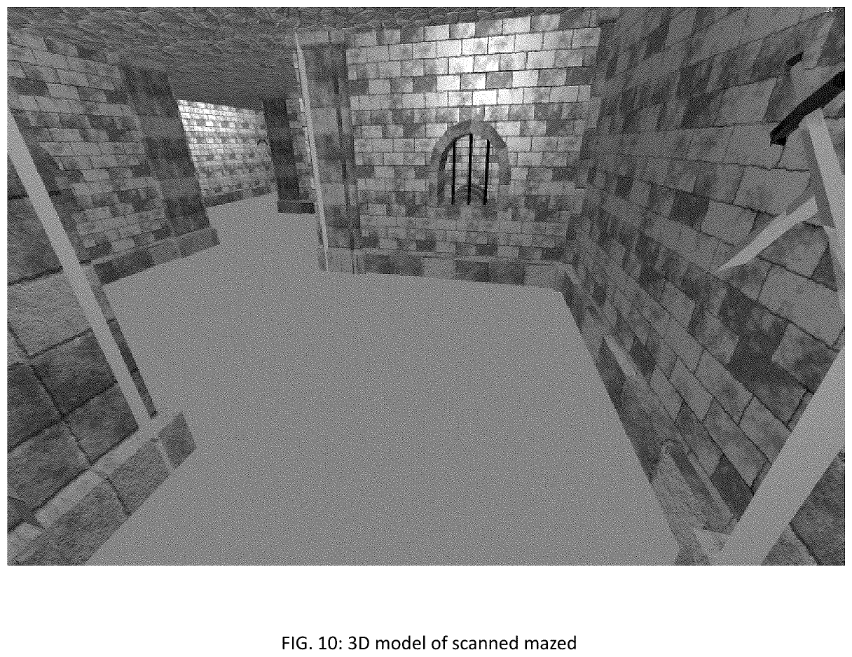

During experimental implementation of system 10, a realistic flight model was used, to generate the drone's 10 flight trajectory. As depicted in FIG. 10, during these experiments a commercially available graphic engine simulated a field of view (FOV) of a survey device 60 such as a camera 60, that is mounted on the drone 10.

During these simulations, an efficiency of the zigzag conduction algorithm, for covering or surveying an area of an unmapped maze calculated. In each experiment, the size and the complexity of the maze were increased. In each experiment the 3D engine simulated the drone flight according to the above zigzag algorithm according to the following equations:

$$w = ( W / \#vertical - walls ) \qquad Eq . 2 A$$

$$z = w \cdot cos ( α ) \qquad Eq . 2 B$$

$$h = w \cdot tan ( α ) \qquad Eq . 2 C$$

where W is the width of the maze, and #vertical-walls is the maximal number of vertical walls crossing any horizontal line.

For an W×H (W-width, H-height) maze, the flight length of device 10 in the maze (denoted Dmin^{α}) may be bound from below, according to the following equation:

$${Dmin}^{{α}^{∘}} = \#vertical - walls \cdot ( H / h ) \cdot z \qquad Eq . 3$$

Eq. 3 optimistically estimates that each rectangular space between vertical walls of the maze may be covered in only one pass of a zigzag movement done at angle α. For example, a dead-end corridor may require at least two passes (up-forward and up-backward) of a [2; 3]+[0; 1] zigzag movement. Additionally, Eq. 3 does not count turns of device 10. As such, Dmin may be regarded as a lower-bound on the length and/or time needed to fully cover the maze.

As for the zigzag angle (wall hitting angle and the wall return angle) or a, it varies by the algorithm basically starting from α=45° down to α=22° and even less. Thus, an average for Dmin, namely Dmin=(Dmin^{45°}+) Dmin^{22°}/2, may be used.

In every experiment, the flight trajectory which the drone made during these Dmin time units was recorded and plotted on a 2D map of the maze. The flight trajectory was plotted in different colors according to the order in which the flight's segments occurred. The walls of the maze were marked by thick dashed lines. The walls (vertical and horizontal) of the maze were randomly generated (length and position) by the engine as a function of W+H.

When the Dmin time-steps are over, the engine counts how many of the w×h^{α=33°} squares of the maze have been visited by the drone and how many w×h^{α-33°} squares were not visited. This ratio measures the efficiency of the zigzag algorithm, e.g., 0.9 of the maze were covered in Dmin steps is considered as high efficiency of the zigzag algorithm. In this ratio, squares that belong to bad-zones (parts of the maze with no possible entrance) should not be counted. The maze size W×H is in meters, thus Dmin is also in meters.

Reference is also made to FIG. 9, which is an image depicting a result of a simulated experiment, where an autonomous device is set to scan a 50×42 maze, according to some embodiments of the invention.

FIG. 9 depicts the results of an experiment, where a 50×42 maze was scanned according to some embodiments of the invention. As shown in FIG. 9, the inventors have tested W=42, and H=50 meters maze as depicted in FIG. 9. #vertical-walls=5, w=42/5=8.4, h=8.4.0.41=3.44, and z=8.4/0.92=9.13, hence Dmin^{22°}=5·(50/3.44)·9.13=663.

For α=45°, h=8·4·1=8.4, and z=8.4/0.7=12, hence Dmin^{45°}=5·(50/8·4)·12=357.14. Thus, Dmin=(663+357)/2=510 meters.

For a grid with h×w=6·8·4 the inventors obtained a grid with 39 (not including bad-zones) squares out of which the drone covered 36 squares yielding covering ratio 36/39=0.92 All other experiments with different maze-size obtained similar results, around 92% cover.

As elaborated herein, embodiments of the invention may allow an autonomous device 10 to traverse an unknown maze without going through the steps of a) localization, b) generation of the 3D-map, and c) computing an obstacle-free path, as done by currently available navigation system. Nevertheless, embodiments of the invention may facilitate mapping of the device's surroundings as a byproduct of the traversed course.

For example, as shown in FIG. 2, device 10 may include, or may be communicatively connected to one or more accelerometer modules 40. The one or more accelerometer modules 40 may be configured to continuously (e.g., repeatedly, over time) produce an acceleration data element 40DE, representing acceleration of device 10 in at least one of three orthogonal axes (e.g., up-down, left-right, and forward-backward). Additionally, device 10 may include a mapping module 120, configured to continuously calculate a location data element 120L, representing a relative location of device 10 (e.g., relative to a predetermined start point). Mapping module 120 may accumulate location data element 120L to produce a map 120M. Map 120M may represent a trace of device 10 through the maze over time, and may resemble the example of FIG. 9

Additionally, or alternatively, device 10 may include a graphic engine module 130, adapted to produce a three-dimensional (3D) model 130M of map 120M.

FIG. 10 is an image depicting an example of a 3D model of a maze as scanned, or traversed by autonomous device 10, according to some embodiments of the invention. In some embodiments, graphic engine module 130 may blow obstacles in a 2D map 120M to produce 3D model 130M, as depicted in FIG. 10. Additionally, or alternatively, graphic engine module 130 may combine additional input, such as images from one or more surveying devices (e.g., cameras) 60 or sensors 30 (e.g., LIDARS) into map 120, to produce 3D model 130M.

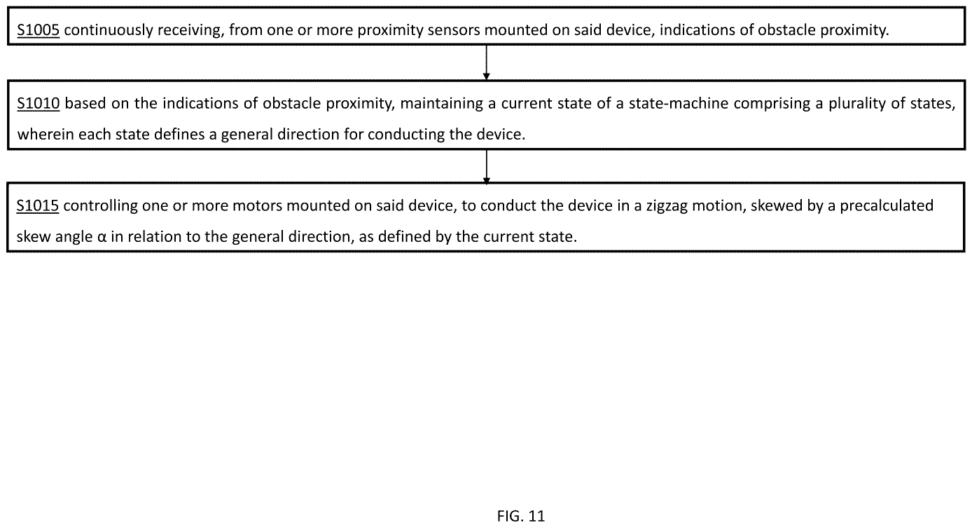

Reference is now made to FIG. 11, which is a flow diagram depicting a method of controlling an autonomous device by at least one processor or controller (e.g., controller 2 of FIG. 1) mounted on said device 10, according to some embodiments of the invention.

As shown in step S1005, controller 2 may continuously (e.g., repeatedly, over time) receive, from one or more proximity sensors 30 (e.g., ultrasonic sensors, sonars, cameras, lidar sensors, radar sensors, and the like), mounted on device 10, indications 30IND of obstacle proximity.

As shown in step S1010, based on the indications of obstacle proximity 30IND, controller 2 may maintain a current state 110CS of a state-machine 110. As elaborated herein, state-machine 110 may include a plurality of states 110S, each defining, or corresponding to a general direction 110G for conducting device 10.

As shown in step S1015 (and depicted in FIG. 2), controller 2 may be associated with one or more motors or actuators 20 that are mounted on, or installed on device 10. As elaborated herein, controller 2 may communicate with motors or actuators 20, to control the one or more motors 20, to conduct device 10 in a zigzag motion.

As shown e.g., in FIG. 4, the zigzag motion may be skewed by a precalculated skew angle α in relation to the general direction 110G, as defined by the current state.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. An autonomous device, comprising one or more motors, one or more proximity sensors, and at least one controller associated with said motors and proximity sensors, wherein the at least one controller is configured to continuously:
receive, from the one or more proximity sensors, indications of obstacle proximity;
based on the indications of obstacle proximity, maintain a current state of a state-machine comprising a plurality of states, wherein each state defines a general direction for conducting the device; and
control said one or more motors to conduct the device in a zigzag motion, skewed by a precalculated skew angle α in relation to the general direction, as defined by the current state.

2. The device of claim 1, wherein the plurality of states comprises at least four states, corresponding to at least four orthogonal general directions.

3. The device of claim 1, wherein at least one state is associated with a respective counter, wherein a value of the counter represents repetitions of proximity of the device to a furthermost position in the defined general direction, and wherein the controller is configured to:
when a value of the counter surpasses a first threshold, then recalculate skew angle α; and
control said one or more motors to conduct the device based on the recalculated skew angle α.

4. The device according to claim 1, wherein the controller is configured to, when a value of the counter surpasses a second threshold, then:
switch the current state of the state machine to a next state, that corresponds to an opposite general direction; and
conduct the device based on the opposite general direction.

5. The device of claim 1, wherein the at least one controller is configured to conduct the device in a zigzag motion by:
controlling the one or more motors, to conduct the device in a first direction that is skewed by skew angle α in relation to the general direction, until a first indication of lateral obstacle proximity is received from the one or more proximity sensors; and
controlling the one or more motors, to conduct the device in a second direction that is skewed by an angle that is complementary to skew angle α, in relation to the general direction, until a second indication of lateral obstacle proximity is received from the one or more proximity sensors.

6. The device of claim 1, wherein the at least one controller is configured to repeat the zigzag motion until an indication of frontal obstacle proximity is received from the one or more proximity sensors.

7. The device of claim 1, wherein the at least one controller is configured to, upon receiving the indication of frontal obstacle proximity:
update the furthermost position in the defined general direction based on a current position of the device; and
update the counter based on the current position of the device.

8. The device of claim 1, further comprising an accelerometer, configured to produce measurements of at least one of an acceleration and a velocity of the device, and wherein the at least one controller is configured to receive said measurements, and calculate the current position of the device based on said measurements.

9. The device of claim 1, wherein the controller is configured to, when a value of the counter surpasses a third threshold, then:
log a current position of the device;
switch the current state of the state machine to a next state, that corresponds to an orthogonal general direction; and
conduct the device based on the orthogonal general direction.

10. The device of claim 9, wherein the controller is further configured to:
when a furthermost position of the device, in the orthogonal general direction exceeds the logged position, then defining an area surrounding the logged position as a virtual barrier; and
avoid conducting the device through the virtual barrier.

11. The device of claim 1, wherein the controller is further configured to:
receive a boundary data element, defining boundaries of an area of interest;
divide the area of interest to a plurality of sections, according to a predefined resolution;
count a number of sections that the device has traversed during said conduction; and
provide an indication of area coverage based on said counting.

12. A method of controlling an autonomous device by at least one processor mounted on said device, the method comprising:
continuously receiving, from one or more proximity sensors mounted on said device, indications of obstacle proximity;
based on the indications of obstacle proximity, maintaining a current state of a state-machine comprising a plurality of states, wherein each state defines a general direction for conducting the device; and
controlling one or more motors mounted on said device, to conduct the device in a zigzag motion, skewed by a precalculated skew angle α in relation to the general direction, as defined by the current state.

13. The method of claim 12, wherein the plurality of states comprises at least four states, corresponding to at least four orthogonal general directions.

14. The method of claim 12, wherein at least one state is associated with a respective counter, wherein a value of the counter represents repetitions of proximity of the device to a furthermost position in the defined general direction, and wherein the method further comprises:
when a value of the counter surpasses a first threshold, then recalculating skew angle α; and
controlling said one or more motors to conduct the device based on the recalculated skew angle α.

15. The method of claim 12, further comprising when a value of the counter surpasses a second threshold, then:
switching the current state of the state machine to a next state, that corresponds to an opposite general direction; and
conducting the device based on the opposite general direction.

16. The method of claim 12, wherein conducting the device in a zigzag motion further comprises:
controlling the one or more motors, to conduct the device in a first direction that is skewed by skew angle α in relation to the general direction, until a first indication of lateral obstacle proximity is received from the one or more proximity sensors; and
controlling the one or more motors, to conduct the device in a second direction that is skewed by an angle that is complementary to skew angle α, in relation to the general direction, until a second indication of lateral obstacle proximity is received from the one or more proximity sensors.

17. The method of claim 12, further comprising repeating the zigzag motion until an indication of frontal obstacle proximity is received from the one or more proximity sensors.

18. The method of claim 12 further comprising, upon receiving the indication of frontal obstacle proximity:
updating the furthermost position in the defined general direction based on a current position of the device; and
updating the counter based on the current position of the device.

19. The method of claim 12, further comprising:
receiving, from an accelerometer mounted on the device, measurements of at least one of an acceleration and a velocity of the device; and
calculating the current position of the device based on said measurements.

20. The method of claim 12 further comprising, when a value of the counter surpasses a third threshold:
logging a current position of the device;
switching the current state of the state machine to a next state, that corresponds to an orthogonal general direction; and
conducting the device based on the orthogonal general direction.

21. (canceled)

22. (canceled)
